(19) United States
(12) Patent Application Publication
(10) Pub. No.: US 2017/0198507 A1
(43) Pub. Date: Jul. 13, 2017

(54) ADJUSTABLE PIVOT SET

(71) Applicant: Steven HUMBLE, (US)

(72) Inventors: Steven HUMBLE, Gilbert, AZ (US); Travis HUMBLE, Mesa, AZ (US)

(21) Appl. No.: 15/472,169

(22) Filed: Mar. 28, 2017

Related U.S. Application Data
(63) Continuation-in-part of application No. 12/261,018, filed on Oct. 29, 2008, now Pat. No. 9,605,457.

(51) Int. Cl. E05D 7/04; E05D 3/02

(52) U.S. Cl. CPC E05D 7/04; E05D 7/0423; E05D 3/02; E05D 2007/0492; E05Y 2900/21; E05Y 2900/132; E05Y 2900/102

(57) ABSTRACT

A three-dimensionally adjustable pivot set may support a pivotable element such as a door. A pivot set housing has an adjustable pivot hub adjustable in lateral dimensions by set screws passing through the housing, the set screws bearing against the pivot hub and being adapted to move the pivot hub in corresponding independent directions when turned. The pivot set is attached to a pivotable element by an adjustable-height assembly for adjustment in a third dimension.

### CROSS-REFERENCE TO RELATED APPLICATIONS

This application claims the benefit of U.S. patent application Ser. No. 12/261,018, filed Oct. 29, 2008, and titled “THREE-DIMENSIONALLY ADJUSTABLE PIVOT DEVICE,” the entire contents of which are hereby incorporated herein by reference.

### BACKGROUND

Technical Field

the present disclosure relates generally to pivot sets. In particular, the present disclosure relates to adjustable pivot sets.

Description of Related Art

It may be desirable for a door to be mounted precisely and in alignment with adjacent sections of wall in order to make the door flush with the wall. A precisely mounted door that is flush with adjacent sections of wall can have a high aesthetic value. In some cases, it may be desirable for a door to be hidden. A hidden door may be disguised as a paneled wall or as a piece of furniture such as a bookcase or cabinetry. A hidden door that is precisely installed may be more likely to blend in with its surroundings and give the appearance of an unbroken wall with no indication of a passageway.

Due to the changeable nature of some buildings and/or building materials, a precise door installation may be difficult to maintain. Wood or other building materials can expand, contract, or otherwise deform over time and/or in response to changes in external factors such as humidity and temperature. The foundation of a building may settle or otherwise move. These shifts can result in changes to a doorframe and thus cause the door to not precisely fit in the doorframe.

A typical technique to correct a door that does not precisely fit in a doorframe may include remounting the door hinges. Several challenges may be faced in this process. For example, remounting a door may call for a substantial amount of manual labor, which may be undesirable. Additionally, if the adjustment amount is small, then the mounting hardware may find their original holes, which may make it difficult to maintain the adjustment. Subsequent mountings may also weaken the door mount.

Many heavy or thick doors may suffer from the foregoing challenges, especially doors which require a tight seal when closed. Particular examples include cold room doors, safe doors, hidden doors, clean room doors, and any other type of door requiring precise mounting placement.

### SUMMARY

In one embodiment of the present disclosure, a pivot device is disclosed. The pivot device has a pivot hub, a first set screw, a second set screw, and a third set screw. The first set screw has a first end-point abutted against the pivot hub. The first set screw is axially aligned in a first adjustment direction. The second set screw has a second end-point abutted against the pivot hub. The second set screw is axially aligned in a second adjustment direction. The third set screw includes a third end-point having free rotation relative to the pivot hub. The third set screw is axially aligned with the pivot hub. The third set screw is screwed into a threaded hole on a door mounting bracket.

In another embodiment, a method for adjusting a pivot hub is disclosed. The method includes: determining a first adjustment distance in a first adjustment dimension, rotating a first set screw of a pivot assembly, determining a second adjustment distance in a second adjustment dimension, rotating a second set screw of the pivot assembly, determining a third adjustment distance in a third adjustment dimension, and rotating a third set screw of the pivot assembly. The first set screw has a first end-point abutted against the pivot hub and is axially aligned in the first adjustment dimension. The first set screw is rotated until the first end-point has moved approximately the first adjustment distance. The second set screw has a second end-point abutted against the pivot hub and is axially aligned in the second adjustment dimension. The second set screw is rotated until the second end-point has moved approximately the second adjustment distance. The third set screw is in axial alignment with the pivot hub and the third adjustment dimension. The third set screw is screwed into a threaded hole on a door mounting bracket. The third set screw is rotated relative to the threaded hole on the door mounting bracket until the door mounting bracket has moved relative to the third set screw approximately the third adjustment distance.

In an additional embodiment, a pivot device is disclosed. The pivot device includes a first pair of opposing and axially aligned horizontal set screws, a second pair of opposing and axially aligned horizontal set screws, a pivot hub, a door mounting bracket, and a vertical set screw. Each of the set screws in the first pair and the set screws in the second pair has a respective end-point. The pivot hub is adjacent to the respective end-points of the set screws in the first pair and the respective end-points of the set screws in the second pair. The door mounting bracket has a threaded hole. The vertical set screw is in vertical alignment with the pivot hub. The vertical set screw is configured to freely rotate relative to the pivot hub. The vertical set screw is screwed into the threaded hole of the door mounting bracket.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope thereof to those skilled in the art.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a perspective view of a pivot device according to one embodiment of the present disclosure;

FIG. 2 is an elevation view of a pivot device according to one embodiment of the present disclosure;

FIG. 3 is a section view a pivot device according to one embodiment of the present disclosure;

FIG. 4 is a plan view of a pivot device according to one embodiment of the present disclosure;

FIG. 5 is a plan view from below of a pivot device according to one embodiment of the present disclosure;

FIG. 6 is an exploded view of a pivot device according to one embodiment of the present disclosure;

FIG. 7 is a perspective view of a pivot device according to a second embodiment of the present disclosure;

FIG. 8 is a plan view of a pivot device according to a second embodiment of the present disclosure;

FIG. 9 is an elevation view of a pivot device according to a second embodiment of the present disclosure;

FIG. 10 is an illustration of a pivot device installation according to a second embodiment of the present disclosure; and

FIG. 11 is a detail view of a pivot device installation according to a second embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Embodiments of the present disclosure provide methods, apparatus, components, and/or techniques for adjusting a pivot set in multiple dimensions. According to various embodiments of the present disclosure, an adjustable pivot set includes one or more set screws for adjusting the position of a bearing relative to mounting points. Such adjustments may be made in multiple dimensions by rotating set screws that are axially aligned in that dimension.

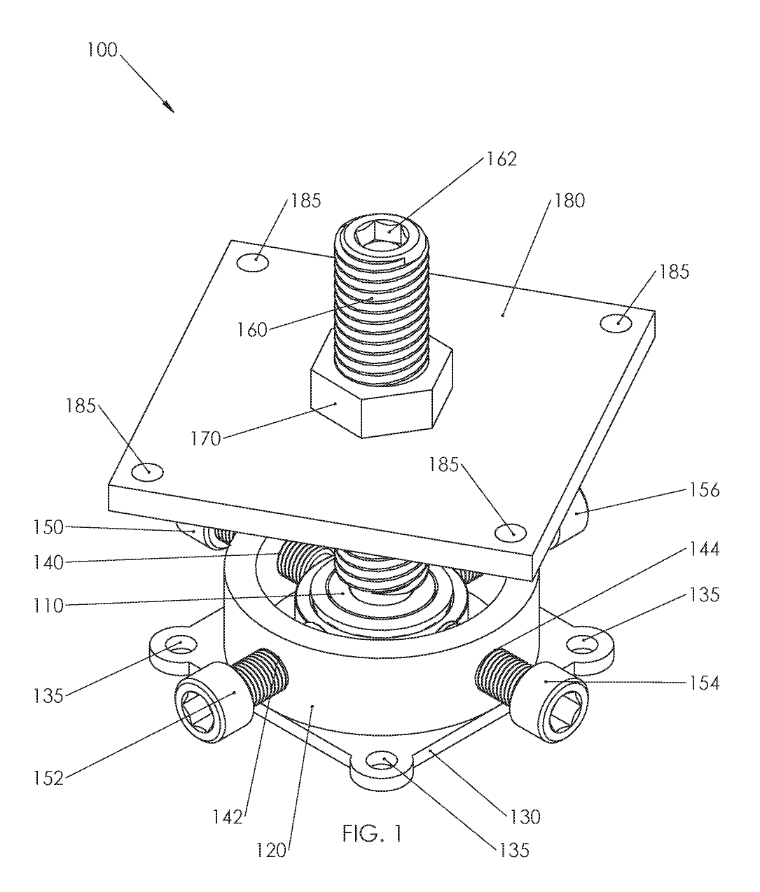

Referring now to FIG. 1, a pivot device 100 according to one embodiment of the present disclosure is depicted. In various embodiments, pivot device 100 comprises a bearing 110 that forms a pivot point of an attached door or other pivotable element. In one embodiment, bearing 110 is placed within housing sleeve 120. In the embodiment depicted in FIG. 1, housing sleeve 120 comprises a cylindrical hollow structure that encircles bearing 110. In embodiments, housing sleeve 120 is mounted to a base plate 130 for anchoring pivot device 100 at a mounting point.

In embodiments, housing sleeve 120 comprises multiple threaded holes 140, 142, 144, 146 passing therethrough. Horizontal set screws 150, 152, 154, 156 are threaded into respective holes 140, 142, 144, 146 with the end-point of each horizontal set screw 150, 152, 154, 156 borne against an outer surface of bearing 110. Rotation of horizontal set screws 150, 152, 154, 156 in a tightening direction (which, based on common convention, may be clockwise) can move end-points of respective horizontal set screws 150, 152, 154, 156 toward bearing 110 and/or increasing a holding force between end-points of respective horizontal set screws 150, 152, 154, 156 and bearing 110. Conversely, rotation of horizontal set screws 150, 152, 154, 156 in a loosening direction (which, based on common convention, may be counter-clockwise) can release a holding force between end-points of respective horizontal set screws 150, 152, 154, 156 and bearing 110 and/or move end-point away from bearing 110. In one embodiment, each set screw 150, 152, 154, 156 comprises a hex socket head for driving the set screw 150, 152, 154, 156. In other embodiments, various other types of drive configurations may be utilized to twist each set screw 150, 152, 154, 156.

In various embodiments, bearing 110 is not mounted at a fixed position within housing sleeve 120 or base plate 130 and thus may laterally move within housing sleeve 120 as acted upon by horizontal set screws 150, 152, 154, 156. Accordingly, selectively loosening and/or tightening horizontal set screws 150, 152, 154, 156 may provide lateral adjustment of the bearing 110 relative to the mounting point of pivot device 100.

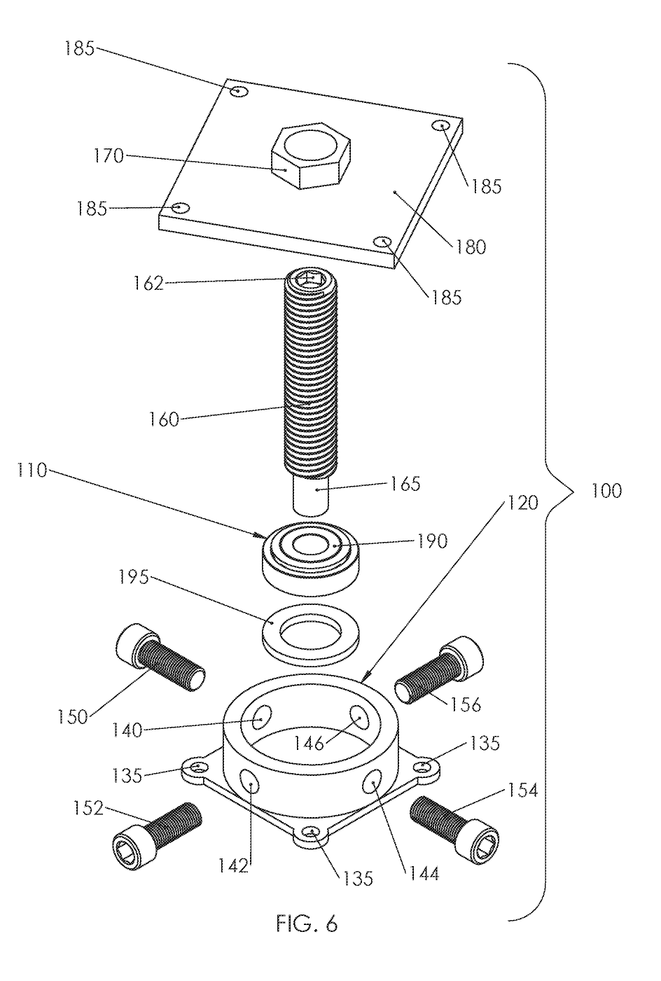

Embodiments of pivot device 100 further comprise vertical set screw 160 having its lower end-point 165 (shown in FIGS. 3 and 6) inserted into bearing 110, with the axis of vertical set screw 160 being approximately aligned with the pivot axis of bearing 110. In one embodiment, vertical set screw 160 comprises a hex socket head 162. Other embodiments comprise other types of screw drive sockets or like features. In one embodiment, vertical set screw 160 is threaded through a threaded fastener 170 that is rotationally fixed to a door bracket mount 180. In one embodiment, threaded fastener 170 is welded to door bracket mount 180. In another embodiment, threaded fastener 170 and door bracket mount 180 are cast, milled, or otherwise manufactured as a single, integral component. In various embodiments, threaded fastener 170 comprises a threaded nut.

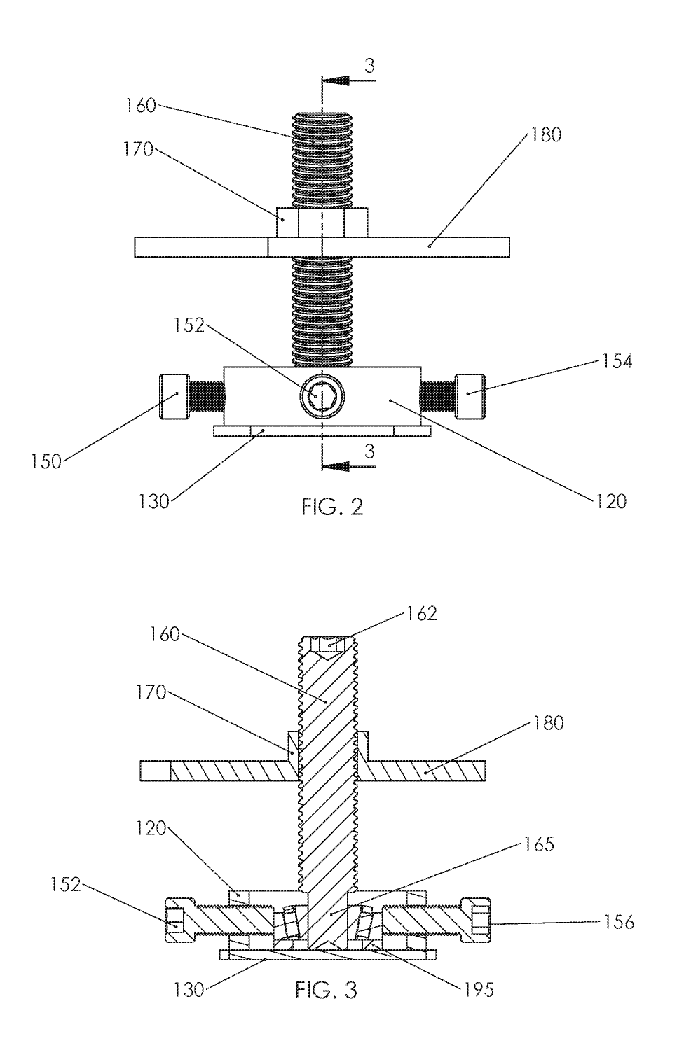

Referring to FIGS. 2 and 3, in embodiments, vertical set screw 160 fits snugly within bearing 110, such that free rotation of set screw 160 within bearing 110 is permitted. In one embodiment, a bearing portion 165 of vertical set screw 160 is not threaded and has a reduced diameter so as to snugly fit into the bearing 110 (or other pivot hub component) and freely rotate therein. In one embodiment, the smaller-diameter end portion 165 of vertical set screw 160 can hold the radial load of a pivotable element while an upward-facing shoulder of a stepped opening 190 of bearing 110 can carry the axial load. Door bracket mount 180 can be raised and lowered relative to base plate 130 by turning vertical set screw 160 relative to threaded fastener 170 to adjust the assembly of door bracket mount 180 and the pivoting element in the vertical dimension. In one embodiment, threaded fastener 170 can freely rotate relative to door bracket mount 180. In this embodiment, door bracket mount 180 can be raised and lowered relative to base plate 130 by turning threaded fastener 170 relative to vertical set screw 160 even while maintaining the rotational position of door bracket mount 180 relative to base plate 130.

The threaded portion of vertical set screw 160 is threaded through threaded fastener 170 such that rotation of vertical set screw 160 relative to threaded fastener 170 in a tightening direction (which, based on common convention, may be clockwise) can move door bracket mount 180 away from bearing 110 and base plate 130. Conversely, rotation of vertical set screw 160 relative to threaded fastener 170 in a loosening direction (which, based on common convention, may be counter-clockwise) can move door bracket mount 180 toward bearing 110 and base plate 130. Thus, the pivotable element may be raised or lowered in relatively fine increments.

In embodiments, bearing 110 comprises a radial thrust bearing adapted to carry the load of a relatively heavy door or other pivotable element. The size and/or carrying capacity of bearing 110 may be tailored to fit the particular circumstances of its use. For example, if the intended use of a particular bearing were a smaller, lighter door, the bearing may have a relatively smaller diameter and fewer bearing components. Conversely, a bearing for a large, heavier door may be relatively large with a greater number of and/or more robust bearing components.

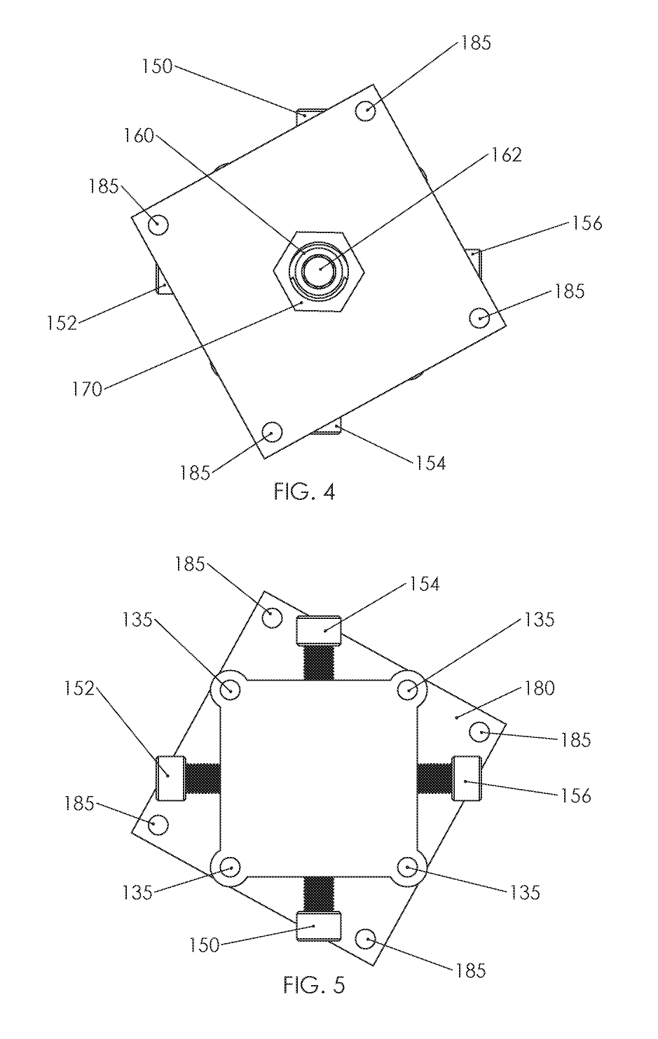

Referring to FIGS. 4 and 5, in embodiments of the present disclosure, base plate 130 and door bracket mount 180 each comprise mounting holes 135, 185 (respectively). Mounting holes 135 may be used to anchor base plate 130 to a door frame, subfloor, or other mounting points on a mounting surface by passing mounting hardware through mounting holes 135 and through the mounting surface. Mounting holes 185 may be used to anchor door bracket mount 180 to a door or other pivotable element.

In embodiments, door bracket mount 180 is mounted to an underside surface of the door. In other embodiments, door bracket mount 180 is mounted to a top surface of the door and the base plate 130 is anchored to a downward facing surface above the pivotable element such as a door frame, a ceiling joist, or other mounting surface.

Door bracket mount 180 can be mounted to the door or other pivotable element by passing mounting hardware through mounting holes 185 and into the pivotable element. In one embodiment, a first pivot device 100 is mounted to an underside surface of the door and a second pivot device 100 is mounted to a top surface of the door, both pivot devices 100 being aligned such that both bearings 110 and set screws 160 are essentially aligned together along a pivot axis of the door or other pivotable element.

As used herein, the term “pivot hub” includes, but is not limited to, a point about which a door or other pivotable element may pivot. In embodiments, a pivot hub may be defined by a vertical axis passing through one or more pivot points. In some embodiments, a pivot hub may be defined by a horizontal axis passing through one or more pivot points. In the present disclosure, the term “pivot hub” may additionally refer to a pivot assembly such as bearing 110 or other assembly that can allow vertical set screw 160 to pivot.

Referring to FIG. 6, horizontal set screws 150, 154 pass through corresponding holes 140, 144 and contact bearing 110 at end-points of horizontal set screws 150, 154. As used herein, the term “end-point” includes, but is not limited to, the end of a set screw such as horizontal set screws 150, 152, 154, 156 that can engage with and secure against a surface. In embodiments, a set screw end-point comprises a focal point of axial thrust between the set screw and the surface. Various types of end-points may be applied to embodiments of the present disclosure, including, but not limited to: cup, cone, oval, flat, other end-point shapes.

In one embodiment of the present disclosure, spacer 195 is placed under bearing 110. According to embodiments, spacer 195 can be used to space bearing 110 from base plate 130 so that the center hub of bearing 110 does not rub on base plate 130 as bearing 110 pivots. In one embodiment, spacer 195 comprises a washer.

As used herein, x, y, and z axes and/or dimensions may refer to three orthogonal directions that typically characterize the three-dimensional Cartesian coordinate system. In embodiments, the x and y dimensions may refer to horizontal directions that are orthogonal to each other, while the z dimension may refer to the vertical dimension.

In operation, an adjustable pivot device can provide fine adjustment in multiple dimensions to a door or other type of pivotable element according to various embodiments of the present disclosure. Adjustment of the pivotable element may be carried out by moving a pivot hub of the pivotable element in one or more dimensions as desired in order to make the pivotable element seat within its frame and/or become flush with neighboring wall panels or adjacent pivotable elements. According to embodiments, such movement may be made independently for each dimension. For example, a pivot hub may be moved in the x dimension for a selected adjustment distance. The pivot hub may alternatively or also be moved in the y dimension for a selected adjustment distance. Each movement distance may be selected independently of each other. Likewise, vertical movement of the pivotable element (in other words, in the z dimension) may be carried out for a selected adjustment distance.

In some cases, a desired lateral adjustment is in a direction that is oblique to both the x direction and the y direction. In such cases, two respective lateral adjustments in the x direction and the y direction may be considered to be components of the desired adjustment and may be carried out to jointly effectuate the desired lateral adjustment.

According to various embodiments of the present disclosure, movement of the bearing within the housing sleeve can be made along the x dimension by turning the two opposing horizontal set screws that are axially aligned in the x dimension, for example, set screws 150 and 154. In embodiments, the horizontal set screws provide counter-force and counter-movement to each other, such that movement of the bearing is induced in one direction by loosening set screw 150 and tightening the opposing set screw 154. To move the bearing within the housing sleeve along the same dimension in the opposite direction, one can loosen set screw 154 and tighten set screw 150. As would be understood by a person of ordinary skill in the art having the benefit of this disclosure, loosening one set screw may be carried out prior to tightening the opposing set screw in order to provide a vacated space into which the bearing can then move by tightening the opposing set screw.

Movement of a door bracket mount 180 can be made along the z dimension by turning the vertical set screw 160 relative to its threaded fastener 170. In embodiments, loosening the vertical set screw 160 can bring bracket mount closer to the base plate of the pivot device. To move the bearing along the z dimension in the opposite direction, one can tighten the vertical set screw relative to the threaded fastener.

According to one embodiment of the present disclosure, a first pivot device is mounted to an underside of a pivotable element while a second pivot device is mounted above pivotable element. The pivot axis of the pivotable element may pass through the bearing component 110 of each pivot device. Both pivot devices may be independently adjusted in the x, y, and/or z dimensions, or various combinations thereof, as described above. Iterative fine-tuning may be carried out after an initial rough-setting of the pivotable element.

In cases where a pivotable element was previously installed and set in place, but a subsequent building foundation shift, deformation of building frame, or other similar movement upset the positioning of the pivotable element, adjustment of pivot devices may once again be carried out by following the foregoing operations until the pivotable element is in a satisfactory position. Additional adjustments may be carried out as desired or called for following further movement of the setting.

Various embodiments of the present disclosure comprise a base plate and/or door bracket mount having sizes and/or configurations that are selected to suit particular installations or circumstances. For example, a relatively larger and/or heavier pivotable element base plate and/or door bracket mount may call for a base plate and/or door bracket mount that is made of thicker material or larger components. A base plate and/or door bracket mount having a larger mounting surfaces may provide a more secure attachment to both a door and anchor points. Some embodiments of a base plate and/or door bracket mount include multiple plates for attaching to multiple corresponding surfaces of a door and/or anchor points.

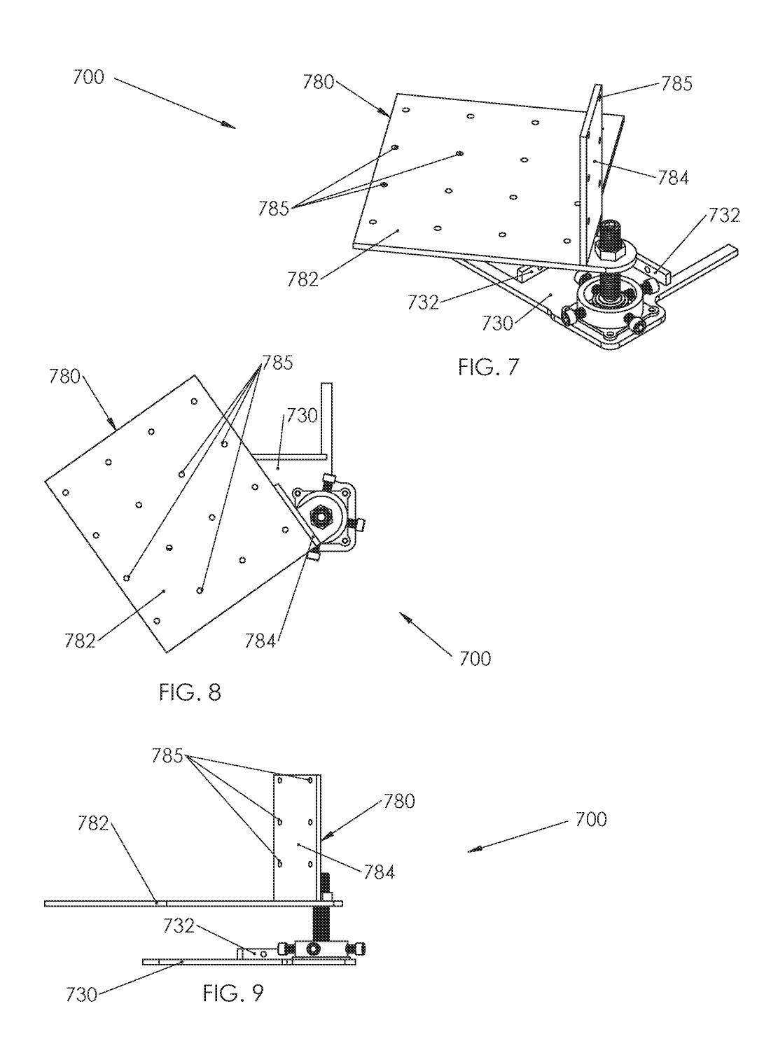

For example, referring to FIGS. 7-9, one embodiment of a pivot device 700 comprises base plate 730 having an L-shaped area. Base plate 730 may be suited to distribute shear forces across a relatively wider area than base plate 130. Embodiments of base plate 730 include vertical attachment points 732 for securing to corresponding vertical anchor surfaces.

As shown in FIGS. 8 and 9, one embodiment of door bracket mount 780 comprises a bracket having a horizontal plate 782 and a vertical plate 784, wherein each plate 782 and 784 comprises mounting holes for mounting to two surfaces of a pivotable element at a corner thereof. For example, a heavy door or other large pivotable object can be secured at a bottom surface of the pivotable element via mounting holes 785 on horizontal plate 782 and secured at a side-facing surface of the pivotable element via mounting holes 785 on vertical plate 784. A second pivot device 700 may be similarly installed to a top of the door or other pivotable element.

As shown in FIG. 8, embodiments of horizontal plate 782 include a relatively large surface area in comparison to door bracket mount 180. The larger surface area of horizontal plate 782 may allow pivot device 700 to carry a heavier pivotable element and/or distribute the weight of said pivotable element across a larger anchoring area.

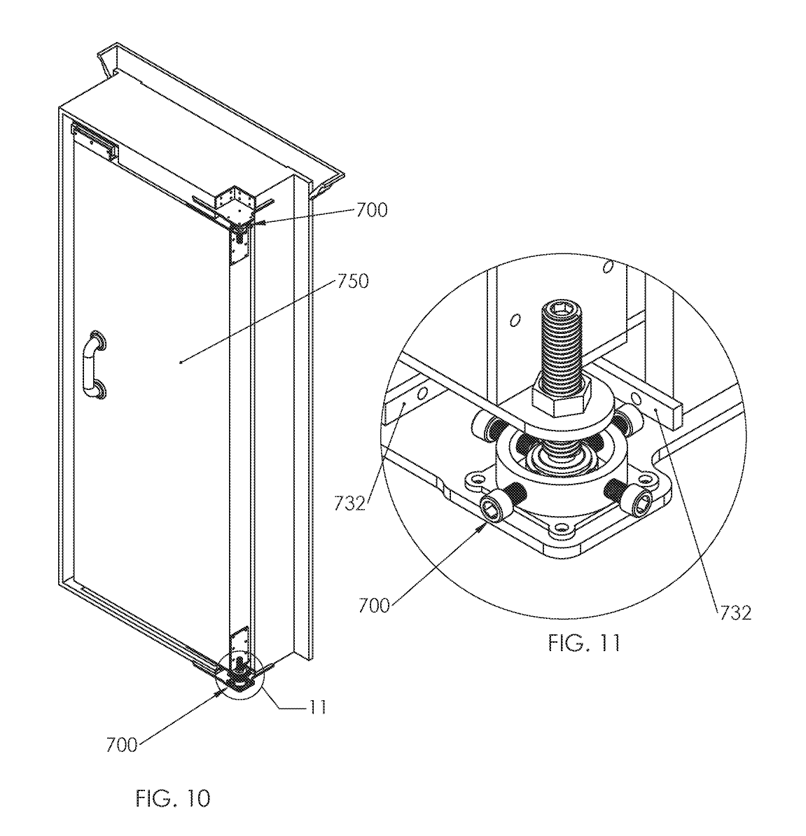

Referring to FIGS. 10 and 11, in embodiments of the present disclosure, pivot device 700 comprises an apparatus for supporting a pivotable element 750, such as a door, for allowing pivoting of the pivotable element 750, and mechanisms for adjusting a pivot point in multiple dimensions in order to adjust the position of the pivotable element 750 for a desired angle of pivot and rest position of the pivotable element 750.

In one embodiment, the pivotable element comprises a pivotable section of a wall, wherein pivot device 700 rests within the confines of the pivotable section of wall not visible through the section of wall, so that adjusting the pivot device 700 in the x, y, and/or z dimensions aligns the movable wall to stand flush and even with the other wall panels and/or to align evenly with the floor so that the movable section of wall appears to be part of the wall when closed. The pivotable section of wall may comprise an entrance to a concealed passageway through the wall.

In addition to the movable section of wall, embodiments of the present disclosure may be used with virtually any pivotable element which may comprise one of various pivotable elements including, but not limited to: a hidden vault cover, a heavy door, a thick door, a tight-seal door, a cold room door, a safe door, a clean room door, or any door requiring precision in opening, closing, and/or remaining flush and even with adjacent wall panels. In some embodiments, the pivotable element comprises a hidden door that is disguised as a piece of furniture such as a bookcase or cabinetry.

In the present disclosure, the terms “approximate,” “approximately,” and other variations thereof in reference to distances, angular alignment, or other physical/spatial relationships may be understood by a person of ordinary skill in the art having the benefit of this disclosure to mean within an acceptable margin of error for the types of installation and/or apparatus employed therein. For example, an acceptable margin of error may be within 5% of the stated value. In another example, an acceptable margin of error may be within one-eighth of an inch of the stated value. In another example, an acceptable margin of error may be within 3 millimeters of the stated value. In another example, an acceptable margin of error may be within 1.5 millimeters of the stated value. In another example, an acceptable margin of error may be within 3 degrees of the stated value. In another example, an acceptable margin of error may be within 5 degrees of the stated value.

Although the present disclosure is described in terms of certain preferred embodiments, other embodiments will be apparent to those of ordinary skill in the art having the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A pivot device, comprising:
a pivot hub;
a first set screw comprising a first end-point abutted against the pivot hub, the first set screw being axially aligned in a first adjustment direction;
a second set screw comprising a second end-point abutted against the pivot hub, the second set screw being axially aligned in a second adjustment direction;
a third set screw comprising a third end-point having free rotation relative to the pivot hub, wherein:
the third set screw is axially aligned with the pivot hub and
the third set screw is screwed into a threaded hole on a door mounting bracket.

2. The pivot device of claim 1, wherein the pivot hub comprises a bearing.

3. The pivot device of claim 2, wherein the bearing comprises a thrust bearing.

4. The system of claim 1, wherein:
the first set screw is screwed into a first horizontally-oriented threaded hole and the second set screw is screwed into a second horizontally-oriented threaded hole and
the first threaded hole and the second threaded hole pass through a housing encircling the pivot hub.

5. The system of claim 4, wherein the housing is mounted to a surface below the pivot device.

6. The system of claim 4, wherein the housing is mounted to a surface above the pivot device.

7. The pivot device of claim 1, wherein the door mounting bracket is affixed to a pivotable element.

8. The pivot device of claim 7, wherein the pivotable element comprises a door.

9. A method for adjusting a pivot hub, comprising:
determining a first adjustment distance in a first adjustment dimension;
for a first set screw of a pivot assembly, the first set screw having a first end-point abutted against the pivot hub, the first set screw being axially aligned in the first adjustment dimension, rotating the first set screw until the first end-point has moved approximately the first adjustment distance;
determining a second adjustment distance in a second adjustment dimension;
for a second set screw of the pivot assembly, the second set screw having a second end-point abutted against the pivot hub, the second set screw being axially aligned in the second adjustment dimension, rotating the second set screw until the second end-point has moved approximately the second adjustment distance;
determining a third adjustment distance in a third adjustment dimension;
for a third set screw of the pivot assembly, the third set screw being in axial alignment with the pivot hub and the third adjustment dimension, the third set screw being screwed into a threaded hole on a door mounting bracket, rotating the third set screw relative to the threaded hole on the door mounting bracket until the door mounting bracket has moved relative to the third set screw approximately the third adjustment distance.

10. The method of claim 9, wherein the third adjustment dimension comprises a vertical dimension.

11. The method of claim 9, wherein the pivot comprises a bearing.

12. The method of claim 9, further comprising:
rotating a fourth set screw of the pivot assembly, the fourth set screw having a fourth end-point abutted against the pivot hub and being on an opposite side thereof from the first set screw, the first set screw being axially aligned in the first adjustment dimension, until the fourth end-point has moved approximately the first adjustment distance;
rotation a fifth set screw of the pivot assembly, the fifth set screw having a fifth end-point abutted against the pivot hub and being on an opposite side thereof from the second set screw, the fifth set screw being axially aligned in the second adjustment dimension, until the fifth end-point has moved approximately the second adjustment distance.

13. A pivot device comprising:
a first pair of opposing and axially aligned horizontal set screws;
a second pair of opposing and axially aligned horizontal set screws
wherein each one of the set screws in the first pair and the set screws in the second pair has a respective end-point;
a pivot hub adjacent to the respective end-points of the set screws in the first pair and the respective end-points of the set screws in the second pair;
a door mounting bracket having a threaded hole; and
a vertical set screw:
in vertical alignment with the pivot hub;
configured to freely rotate relative to the pivot hub; and
screwed into the threaded hole of the door mounting bracket.

14. The pivot device of claim 13, wherein the first pair of set screws is perpendicular to the second pair of set screws.

15. The pivot device of claim 13, wherein the pivot hub comprises a bearing.

16. The pivot device of claim 15, wherein the bearing comprises a thrust bearing.

17. The pivot device of claim 13, further comprising a base, wherein:
each one of the first pair of set screws is screwed into a first pair of respective horizontally-oriented threaded hole;
each one of the second pair of set screws is screwed into a second pair respective horizontally-oriented threaded hole;
each one of the first pair of respective horizontally-oriented threaded holes are on opposite sides of the pivot hub from each other;
each one of the second pair of respective horizontally-oriented threaded holes are on opposite sides of the pivot hub from each other;
said horizontally-oriented threaded holes pass through the base.

18. The pivot device of claim 17, wherein the base is mounted to a surface below the pivot device.

19. The pivot device of claim 17, wherein the base is mounted to a surface above the pivot device.

20. The pivot device of claim 13, wherein the door mounting bracket is affixed to a pivotable element.
